(19) United States
(12) Patent Application Publication
(10) Pub. No.: US 2016/0374009 A1
(43) Pub. Date: Dec. 22, 2016

(54) Operation of a Communication Unit in a Wireless Local Area Network, WLAN, Environment

(71) Applicant: TELEFONAKTIEBOLAGET LM ERICSSON (PUBL), Stockholm (SE)

(72) Inventors: Guido Hiertz, Aachen (DE); Filip Mestanov, Sollentuna (SE); Håkan Persson, Solna (SE); Johan Söder, Stockholm (SE); Leif Wilhelmsson, Dalby (SE)

(73) Assignee: Telefonaktiebolaget L M Ericsson (publ), Stockhom (SE)

(21) Appl. No.: 14/891,502

(22) PCT Filed: Feb. 17, 2015
(86) PCT No.: PCT/SE2015/050181

§ 371 Date: Nov. 16, 2015

(51) Int. Cl. H04W 48/16; H04W 8/00

(52) U.S. Cl. CPC H04W 48/16; H04W 8/005; H04W 88/12

(57) ABSTRACT

There is provided a method of operation of a communication unit in a Wireless Local Area Network, WLAN, environment. The method comprises the step (S1) of the communication unit embedding identification information into at least the Physical, PHY, preamble of the PHY header of a WLAN frame. The method also comprises the step (S2) of the communication unit performing transmission of the WLAN frame for enabling a recipient to identify i) the communication unit and/or ii) a WLAN to which the communication unit is associated, and/or iii) whether the transmission originates from a member of a specific group of communication units based on the embedded identification information.

### TECHNICAL FIELD

The proposed technology generally relates to Wireless Local Area Network, WLAN, technology, and more specifically relates to method(s) of operation of a communication unit in a WLAN environment, communication unit(s) configured for operation in a WLAN environment, as well as corresponding computer program(s) and computer-program product(s), and apparatus(es) for WLAN operation.

### BACKGROUND

As the name implies, Wireless Local Area Network, WLAN, technology offers a basis for wireless communications within a local area coverage. In general, the WLAN technology includes industry-specific solutions as well as proprietary protocols, although most commercial applications are based on well-accepted standards such as the various versions of IEEE 802.11, also popularly referred to as Wi-Fi.

IEEE 802.11 is a set of Medium Access Control, MAC, and physical layer, PHY, specifications for implementing WLAN communication in specified frequency bands.

WLAN networks typically employ a so-called contention-based protocol for medium access allowing many users to use the same radio-based medium with little or no pre-coordination. Typically, a transmitter first senses its radio environment, i.e. a radio based medium or channel, before it starts a transmission. The so-called Listen Before Talk, LBT, operating procedure in IEEE 802.11 is one of the most well-known contention-based protocols.

For example, Carrier Sensing Multiple Access, CSMA, is a Medium Access Control, MAC, protocol in which a node verifies the absence of other traffic before transmitting on a shared transmission medium, such as an electrical bus, or a band of the electromagnetic spectrum.

Carrier Sensing means that a transmitter uses feedback from a receiver to determine whether another transmission is in progress before initiating a transmission. That is, it tries to detect the presence of a transmission or carrier wave from another station before attempting to transmit. If a transmission/carrier is sensed, the station waits for the transmission in progress to finish before initiating its own transmission. In other words, CSMA is also based on LBT. Multiple access means that multiple stations send and/or receive on the medium.

IEEE 802.11 includes up to six MAC address fields in a frame. These address fields identify the receiver, destination, transmitter, source, and relaying stations. A station needs to decode a frame to obtain the MAC address information. By way of example, with the receiver address encapsulated into the data part of an 802.11 frame, receiving devices must be able to decode the data part to identify the intended receiver of a frame. If the frame is transmitted at a high Modulation and Coding Scheme, MCS, the intended receiver might not be able to decode the data part and thus cannot know that the frame was destined to it. Consequently the intended receiver cannot signal to the sender that a lower MCS should be used.

Wireless networks using distributed, asynchronous medium access, such as e.g. the Carrier Sense Multiple Access/Collision Avoidance, CSMA/CA, scheme used in IEEE 802.11, typically also suffer from low spectral efficiency in dense deployments. This is due to the fact that stations, STAs, and access points, APs, must refrain, i.e. back-off, from accessing the wireless medium if they sense it is busy. Some of these back-offs are unnecessary, since if the two transmission links are located in separate cells, or using Wi-Fi terminology, different BSSs, and are far apart, ensuring sufficient signal level difference, they may both operate successfully at the same time. Thus, the wireless medium may not be optimally utilized, specifically leading to relatively low spectral efficiency and/or low frequency channel reuse.

One way to enable such simultaneous or concurrent transmissions is by increasing the channel sensing threshold by some scheme, e.g. Dynamic Sensitivity Control, DSC, which has been proposed in the IEEE 802.11 Task Group AX, TGax.

However, such relaxations in the CSMA/CA protocol may result in hidden nodes within a BSS, i.e. creating unwanted collisions at the AP from STAs trying to transmit at the same time.

### SUMMARY

It is an object to provide a method of operation of a communication unit in a Wireless Local Area Network, WLAN, environment.

It is also an object to provide a complementary method of operation of a communication unit in a Wireless Local Area Network, WLAN, environment.

Another object is to provide a communication unit configured for operation in a Wireless Local Area Network, WLAN, environment.

It is also an object to provide a complementary communication unit configured for operation in a Wireless Local Area Network, WLAN, environment.

Yet another object is to provide corresponding computer programs and computer-program products.

Still another object is to provide an apparatus for operation in a Wireless Local Area Network, WLAN, environment.

It is also an object to provide a complementary apparatus for operation in a Wireless Local Area Network, WLAN, environment.

These and other objects are met by embodiments of the proposed technology.

According to a first aspect, there is provided a method of operation of a communication unit in a Wireless Local Area Network, WLAN, environment. The method comprises the step of the communication unit embedding identification information into at least the Physical, PHY, preamble of the PHY header of a WLAN frame. The method also comprises the step of the communication unit performing transmission of the WLAN frame for enabling a recipient to identify i) the communication unit and/or ii) a WLAN to which the communication unit is associated, and/or iii) whether the transmission originates from a member of a specific group of communication units based on the embedded identification information.

According to a second aspect, there is provided a method of operation of a communication unit in a Wireless Local Area Network, WLAN, environment. The method comprises the step of the communication unit receiving a WLAN frame having identification information embedded into at least the Physical, PHY, preamble of the PHY header of the WLAN frame. The method also comprises the step of the communication unit extracting the identification information from the received WLAN frame. The method further comprises the step of the communication unit identifying i) a sender transmitting the WLAN frame and/or ii) a WLAN to which the sender transmitting the WLAN frame is associated, and/or iii) whether the sender transmitting the WLAN frame belongs to a specific group of communication units based on the identification information.

According to a third aspect, there is provided a communication unit configured for operation in a Wireless Local Area Network, WLAN, environment. The communication unit is configured to embed identification information into at least the Physical, PHY, preamble of the PHY header of a WLAN frame. The communication unit is also configured to perform transmission of the WLAN frame for enabling a recipient to identify i) the communication unit and/or ii) a WLAN to which the communication unit is associated, and/or iii) whether the transmission originates from a member of a specific group of communication units based on the embedded identification information.

According to a fourth aspect, there is provided a communication unit configured for operation in a Wireless Local Area Network, WLAN, environment. The communication unit is configured to receive a WLAN frame having identification information embedded into at least the Physical, PHY, preamble of the PHY header of the WLAN frame. The communication unit is also configured to extract the identification information from the received WLAN frame. The communication unit is further configured to identify i) a sender transmitting the WLAN frame and/or ii) a WLAN to which the sender transmitting the WLAN frame is associated, and/or iii) whether the sender transmitting the WLAN frame belongs to a specific group of communication units based on the identification information.

According to a fifth aspect, there is provided a computer program comprising instructions, which when executed by at least one processor, cause the at least one processor to:
embed identification information into at least the Physical, PHY, preamble of the PHY header of a Wireless Local Area Network, WLAN, frame; and
forward the WLAN frame for transmission for enabling a recipient to identify i) the communication unit and/or ii) a WLAN to which the communication unit is associated, and/or iii) whether the transmission originates from a member of a specific group of communication units based on the embedded identification information.

According to a sixth aspect, there is provided a computer program comprising instructions, which when executed by at least one processor, cause the at least one processor to:
read a Wireless Local Area Network, WLAN, frame having identification information embedded into at least the Physical, PHY, preamble of the PHY header of the WLAN frame;
extract the identification information from the received WLAN frame; and
identify i) a sender transmitting the WLAN frame and/or ii) a WLAN to which the sender transmitting the WLAN frame is associated, and/or iii) whether the sender transmitting the WLAN frame belongs to a specific group of communication units based on the identification information.

According to a seventh aspect, there is provided a computer-program product comprising a computer-readable medium having stored thereon a computer program according to the fifth and/or sixth aspect.

According to an eighth aspect, there is provided an apparatus for operation in a Wireless Local Area Network, WLAN, environment. The apparatus comprises an embedding module for embedding identification information into at least the Physical, PHY, preamble of the PHY header of a WLAN frame. The apparatus also comprises an output module for outputting the WLAN frame for transmission for enabling a recipient to identify i) the communication unit and/or ii) a WLAN to which the communication unit is associated, and/or iii) whether the transmission originates from a member of a specific group of communication units based on the embedded identification information.

According to a ninth aspect, there is provided an apparatus for operation in a Wireless Local Area Network, WLAN, environment. The apparatus comprises a reading module for reading a WLAN frame having identification information embedded into at least the Physical, PHY, preamble of the PHY header of the WLAN frame. The apparatus also comprises an extraction module for extracting the identification information from the received WLAN frame. The apparatus further comprises an identification module for identifying i) a sender transmitting the WLAN frame and/or ii) a WLAN to which the sender transmitting the WLAN frame is associated, and/or iii) whether the sender transmitting the WLAN frame belongs to a specific group of communication units based on the identification information.

At least one of the embodiments described herein offers the advantage(s) of improved WLAN performance, improved spectral efficiency, improved channel access, improved possibilities for concurrent WLAN transmissions, increased frequency channel reuse and/or reliable device identification.

Other advantages will be appreciated when reading the detailed description.

### BRIEF DESCRIPTION OF THE DRAWINGS

The embodiments, together with further objects and advantages thereof, may best be understood by making reference to the following description taken together with the accompanying drawings, in which:

FIG. 1 is a schematic diagram illustrating an example of a Wireless Local Area Network, WLAN, environment.

FIG. 2 is a schematic flow diagram illustrating an example of a method of operation of a communication unit in a Wireless Local Area Network, WLAN, environment according to an embodiment.

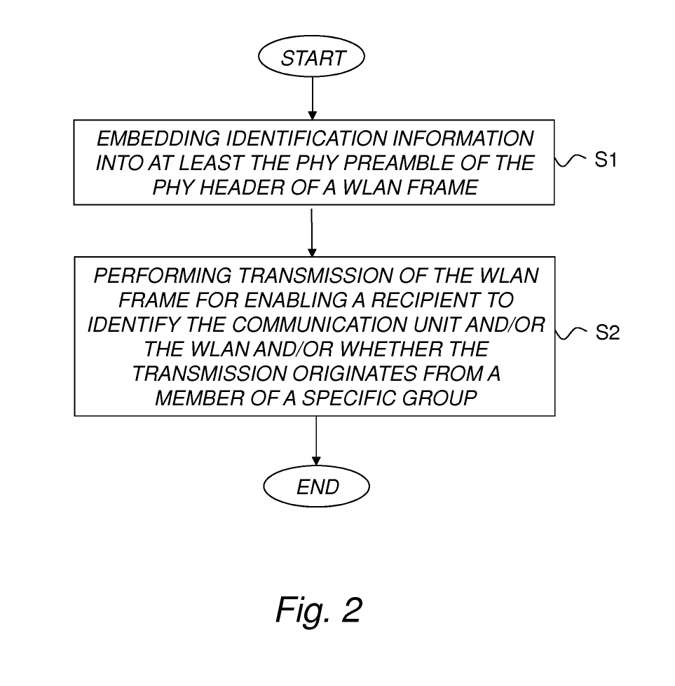

FIG. 3 is a schematic flow diagram illustrating an example of a complementary method of operation of a communication unit in a Wireless Local Area Network, WLAN, environment according to an embodiment.

FIG. 4 is a schematic diagram illustrating an example of actions and signaling according to an embodiment.

FIG. 5 is a schematic diagram illustrating an example of the IEEE 802.11 frame format.

FIG. 6 is a schematic diagram illustrating an example of the frame format with different PHY preambles according to an embodiment.

FIG. 7 is a schematic block diagram illustrating an example of a communication unit according to an embodiment.

FIG. 8 is a schematic block diagram illustrating an example of a complementary communication unit according to an embodiment.

FIG. 9 is a schematic block diagram illustrating an example of a computer implementation according to an embodiment.

FIG. 10A-B are schematic computer flow diagrams.

FIG. 11 is a schematic block diagram illustrating an example of an apparatus according to an embodiment.

FIG. 12 is a schematic block diagram illustrating an example of an apparatus according to another embodiment.

### DETAILED DESCRIPTION

Throughout the drawings, the same reference designations are used for similar or corresponding elements.

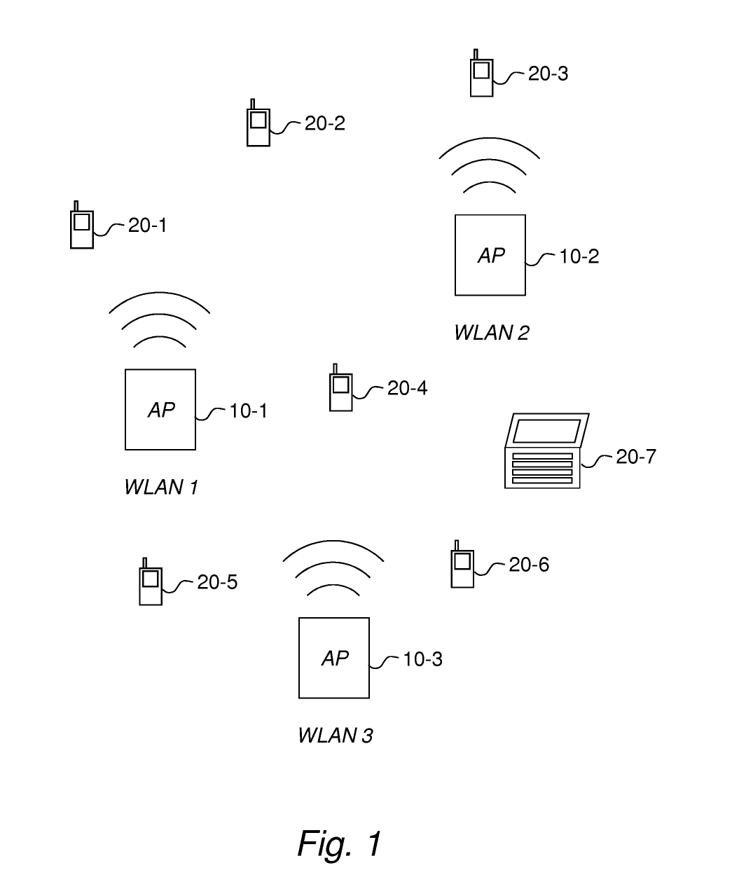

For a better understanding of the proposed technology, it may be useful to begin with a brief overview of an example of a Wireless Local Area Network, WLAN, environment with reference to FIG. 1. In this particular example, the WLAN environment includes a number of networks, WLAN 1, WLAN 2, and WLAN 3, each being associated with a respective access point, AP, 10-1, 10-2, and 10-3, or equivalent network node. The networks operate to serve a number of wireless devices, 20-1 to 20-7, also commonly referred to as stations or client devices.

As used herein, the non-limiting term “network node” may refer to an access point or similar radio network node including access controllers and the like.

As used herein, the non-limiting terms “wireless device” and “station” may refer to a User Equipment, UE, a mobile phone, a cellular phone, a Personal Digital Assistant,

PDA, equipped with radio communication capabilities, a smart phone, a laptop or Personal Computer, PC, equipped with an internal or external mobile broadband modem, a tablet PC with radio communication capabilities, a target device, a device to device UE, a machine type UE or UE capable of machine to machine communication, iPAD, customer premises equipment, CPE, laptop embedded equipment, LEE, laptop mounted equipment, LME, USB dongle, a portable electronic radio communication device, a sensor device equipped with radio communication capabilities or the like. In particular, the term “wireless device” should be interpreted as a non-limiting term comprising any type of wireless device communicating with a radio network node in a wireless communication system or any device equipped with radio circuitry for wireless communication according to any relevant standard for wireless communication.

In the following, both access points/network nodes and the associated wireless devices can be regarded as a form of communication unit configured for operation in a WLAN environment.

According to a first aspect, there is provided a method of operation of a communication unit in a Wireless Local Area Network, WLAN, environment. The method comprises the following steps:
S1: The communication unit embedding identification information into at least the Physical, PHY, preamble of the PHY header of a WLAN frame.
S2: The communication unit performing transmission of the WLAN frame for enabling a recipient to identify i) the communication unit and/or ii) a WLAN to which the communication unit is associated, and/or iii) whether the transmission originates from a member of a specific group of communication units based on the embedded identification information.

In other words, the identification information embedded into at least the PHY preamble of a WLAN frame enables identification of i) the transmitting communication unit and/or ii) the WLAN to which the communication unit is associated, and/or iii) whether the transmission originates from a member of a specific group of communication units.

By way of useful example, the identification information may enable the recipient to take a decision on concurrent use of the shared wireless medium.

For example, the identification information may enable the recipient to identify a WLAN and decide whether to ignore a busy medium condition based on the identified WLAN.

In a particular example, the identification information enables the recipient to identify a WLAN and defer access to the wireless medium if the transmission of the WLAN frame originates from a member of the recipient's own WLAN, and allow/contend for access to the wireless medium if the transmission of the WLAN frame originates from a member of a different WLAN.

Identification of whether the transmission originates from a member of a specific group of communication units could for example be useful to differentiate between an access point transmission, on the downlink, and a client device transmission, on the uplink. It could also be useful to enable the recipient to identify whether the transmission originates from a member of a specific group of client devices.

For example, the recipient may be a client device and the identification information enables the recipient to identify whether the transmission originates from another client device that is using the same identification information in the PHY preamble as the recipient.

As another example, the specific group of client devices may belong to the same WLAN, as previously mentioned.

In a particular example, the identification information may enable the recipient to consider secondary conditions to decide whether concurrent use of the wireless medium is allowed.

It is also possible to use the identification information to enable the recipient to identify the communication unit and provide, upon unsuccessful data decoding, Negative Acknowledgement, NACK, feedback to the identified communication unit.

In a set of example embodiments, the identification information is representative of an Association Identifier, AID.

For example, the AID may be embedded in the Legacy Short Training Field, L-STF, and a selected bit of the Legacy Signal Field, L-SIG, of the PHY header.

By way of example, the AID may be representative of an individual communication unit, a group addressed frame, or an individual WLAN.

As previously mentioned, the communication unit may be an access point or a wireless device.

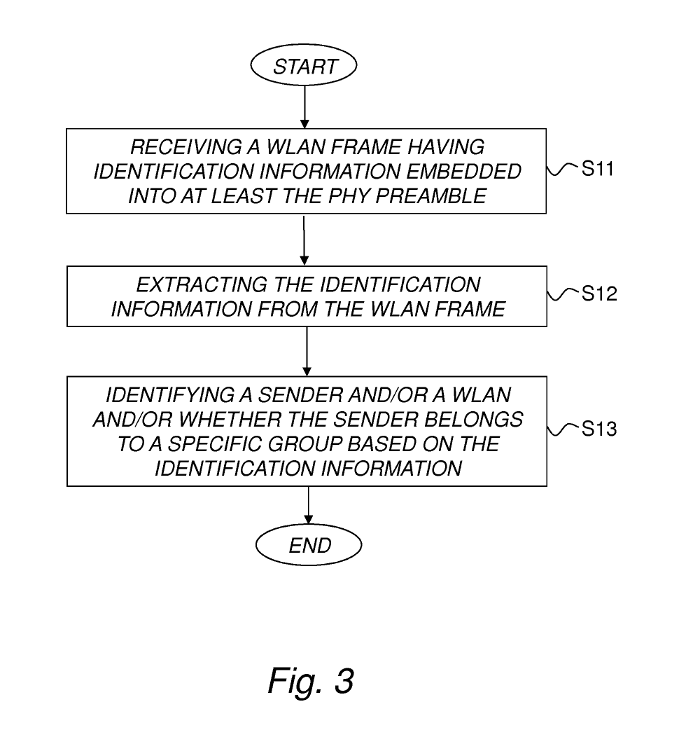

FIG. 3 is a schematic flow diagram illustrating an example of a complementary method of operation of a communication unit in a Wireless Local Area Network, WLAN, environment according to an embodiment. The method comprises the following steps:

S11: The communication unit receiving a WLAN frame having identification information embedded into at least the Physical, PHY, preamble of the PHY header of the WLAN frame.

S12: The communication unit extracting the identification information from the received WLAN frame.

S13: The communication unit identifying i) a sender transmitting the WLAN frame and/or ii) a WLAN to which the sender transmitting the WLAN frame is associated, and/or iii) whether the sender transmitting the WLAN frame belongs to a specific group of communication units based on the identification information.

In other words, the identification information embedded into at least the PHY preamble of a WLAN frame enables identification of i) the transmitting communication unit and/or ii) the WLAN to which the communication unit is associated, and/or iii) whether the transmission originates from a member of a specific group of communication units.

By way of example, the communication unit takes a decision on concurrent use of the shared wireless medium based on the identification information.

For example, the communication unit may identify a WLAN and decide whether to ignore a busy medium condition based on the identified WLAN.

In a particular example, the communication unit identifies a WLAN and defers access to the wireless medium if the received WLAN frame originates from a member of the communication unit's own WLAN, and allows/contends for access to the wireless medium if the received WLAN frame originates from a member of a different WLAN.

Optionally, the communication unit may identify whether the sender transmitting the WLAN frame belongs to a specific group of client devices.

For example, the communication unit may be a client device and the communication unit may then identify whether the received WLAN frame originates from another client device that is using the same identification information in the PHY preamble as the communication unit.

As mentioned, the specific group of client devices may belong to the same WLAN.

Optionally, the communication unit may consider, if the sender transmitting the WLAN frame belongs to a specific group of client devices, secondary conditions to decide whether concurrent use of the wireless medium is allowed.

In a particular application example, the communication unit identifies the sender transmitting the WLAN frame and provides, upon unsuccessful data decoding, Negative Acknowledgement, NACK, feedback to the identified sender.

In a set of example embodiments, the identification information is representative of an Association Identifier, AID.

For example, the AID may be embedded in the Legacy Short Training Field, L-STF, and a selected bit of the Legacy Signal Field, L-SIG, of the PHY header.

The AID may for example be representative of an individual communication unit, a group addressed frame, or an individual WLAN.

The communication unit may for example be an access point or a wireless device.

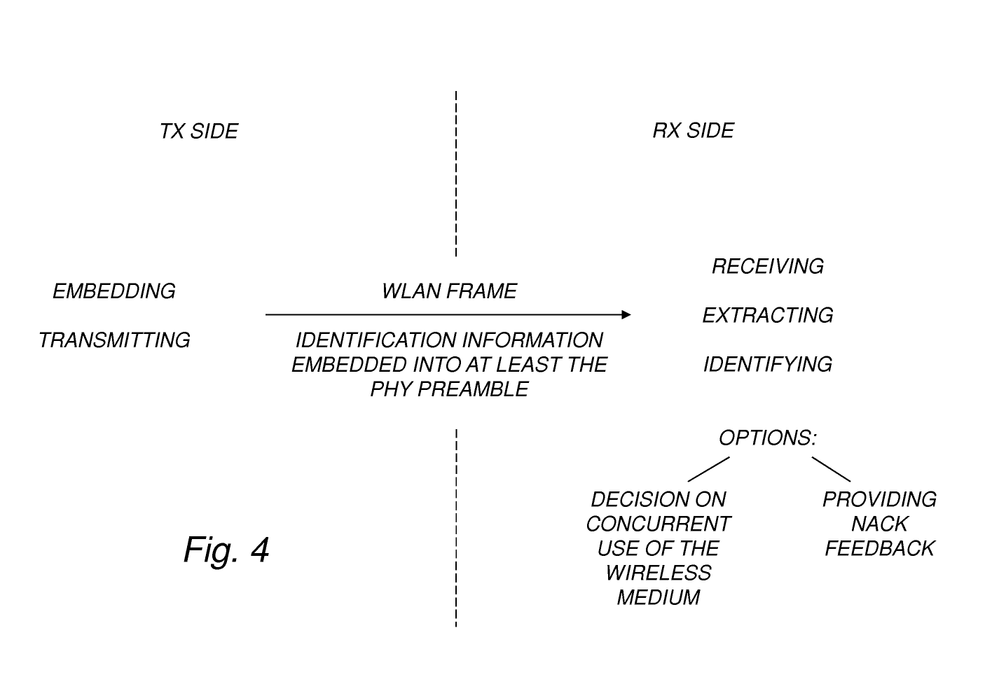

FIG. 4 is a schematic diagram illustrating an example of actions and signaling according to an embodiment. On the transmitting (TX) side, the steps of embedding of identification information into the PHY preamble of a WLAN frame and transmitting of the WLAN frame are performed. The WLAN frame including the identification information embedded into at least the PHY preamble is thus transferred to the receiving (RX) side. On the RX side, the steps of receiving the WLAN frame and extracting the identification information and identifying a sender, a WLAN or a specific group of communication units based on the identification information are performed. Optionally, the receiving side takes a decision on concurrent use of the wireless medium and/or provides NACK feedback based on the identification.

In the following, a few non-limiting examples will be given with particular reference to the 802.11 standard. The proposed technology is not limited to these examples,

The 802.11 standard uses the term BSS to identify a single group of stations that are associated to the same Access Point (AP). We use the more generic term WLAN as a synonym for BSS in the following.

The 802.11 standard subsumes client entities and AP entities under the term station. To differentiate client devices from AP devices the 802.11 standard uses the term non-AP station. As used herein, however, the term station mainly refers to client (non-AP) devices.

By way of example, the identification information may be used to differentiate between transmissions of different Basic Service Sets, BSSs, here referred to as WLANs. Most 802.11 deployments are AP centered. In an apartment complex each household has its own AP. Stations typically communicate only with their AP. E.g. a Wi-Fi TV in apartment N never communicates with the AP or a Blu-Ray player in apartment K. Thus, we can build on the fact that the radio “areas” of the apartments are nicely separated by walls and the traditional, very sensitive carrier sensing threshold isn't needed. Instead of mutually deferring to transmit both apartments (respectively the people/users of communication devices) would be much better off if devices in both apartments would transmit concurrently to each other. This would increase spatial frequency reuse and improve the performance that both can achieve.

One of the possibilities of such PHY based addressing is to extend it from a per-WLAN identification a per-station identification. Then, a very robust identification is available. This robust identification may be useful for generating Negative Acknowledgments.

There may be different input values used by a station to detect the wireless medium to be busy. For example, whenever there is energy on the wireless medium that exceeds the Energy Detection, ED, threshold the station turns into the busy state. If the station is able to recognize an OFDM preamble it turns into the busy state at a much lower threshold. If the station can also read the frame duration from the Signal field in the PHY preamble it will continue to be in the busy state for the indicated duration—even if the measured signal strength should drop below the threshold.

So these are conditions for traditional 802.11 to turn to the busy or idle state. The proposed technology prepends these conditions by a novel identifier. As an example, in case a station knows that a frame “in the air” is transmitted by another fellow station of its own WLAN it can behave differently than if the frame was transmitted by a different WLAN's station.

So a primary condition may then be based on investigating whether a frame is from the own WLAN or from a “foreign” or different WLAN.

In another embodiment a primary condition could be based on identifying whether the transmission originates from a member of a specific group of communication units based on the embedded identification information, and especially a specific group of client devices. Knowing whether a transmission originates from a member of a specific group of client devices would also be useful to prioritize the protection of AP transmissions over station transmissions.

By way of example, secondary conditions may be based on the Clear Channel Assessment, CCA, or Energy Detection, ED, thresholds of 802.11.

For example, in case a station knows that:
1st) a station of a different WLAN transmits (primary condition), and
2nd) the measured signal strength is below a certain (fixed/dynamic) threshold (secondary condition), or
2nd) the measured signal strength is below a certain, MCS-dependent threshold (secondary condition), and
3rd) a central network entity allows for concurrent transmissions (secondary condition), and
4th) certain rules in the standard do not call for extra protection of the ongoing transmission (secondary condition), and
5th) there is only one/there are not more than “n” other transmissions,
   then the station may transmit concurrently to an ongoing transmission.

In an example embodiment, the proposed technology suggests to add identification or addressing information at the PHY header level of an 802.11 frame. As soon as a receiving device notices that the frame is not destined to the WLAN to which this device is associated, the device may ignore the frame and continue to contend for access to the wireless medium.

Current IEEE 802.11 medium access rules mandate low carrier sensing thresholds for OFDM. The threshold meets the requirements of the lowest Modulation and Coding Scheme, MCS, defined in the standard. Thus, in many scenarios a large number of stations must refrain from channel access once they detect a busy wireless medium condition. If a station can differentiate between transmissions in its own and in neighboring WLANs the station may be able to better detect opportunities for concurrent transmissions, ignoring the busy wireless medium condition caused by the neighboring WLAN.

In a completely different area of application, namely based on centralized medium access such as in Power Line Communication, PLC, or Long Term Evolution, LTE, the use of orthogonal PHY preambles is mentioned [2, 4].

Reference [5] proposes orthogonal PHY preambles with IEEE 802.11 WLAN technology in a trigger-based approach.

Reference [6] introduces explicit information in the form of COLOR bits and simplified addressing information to identify transmissions in Overlapping Basic Service Sets, OBSSs, from transmissions in the own BSS.

References [7, 8] are examples that describe the usage of different carrier sensing thresholds. As described therein, the carrier sensing thresholds are selected depending on whether the source of the transmission is with the same or a different WLAN.

In identifying overlapping Basic Service Sets (BSSs) from a station's own BSS a station is enabled to transmit concurrently to other ongoing transmissions.

By way of example, the proposed technology provides a new mechanism that can be used to differentiate between transmissions in different WLANs. Among other things, the technology provides a new mechanism to identify transmissions from a specific WLAN. Thus, a station can identify transmissions of its own WLAN.

Reference [9] merely outlines a basic idea of a “concurrent transmission parameter”. The proposed technology on the other hand presents a solution in which an identifier can be embedded into the PHY header, and more particularly into a frame's preamble structure. Thus, no extra PHY header information is needed.

By way of example, the proposed technology modifies the PHY preamble to allow devices to identify the intended recipient at the earliest possible instance. The present invention proposes different variants of adding such identification information to a PHY preamble.

In a variation, the proposed technology allows for differentiation between AP and STA transmissions. In 802.11 STAs and APs have the same medium access probability. Accordingly, they achieve a similar share of capacity. With seven STAs and one AP, for example, each entity receives ⅛ of the channel's capacity. Since only the AP serves the downlink, DL, the DL's capacity is greatly reduced to ⅛ while STAs in the uplink, UL, altogether achieve a share of ⅞ of the channel's capacity. In prioritizing DL over UL transmissions this imbalance can be reduced. Another means of reducing the imbalance between DL and UL is in configuring medium access parameters for stations that provide lower priority. However, the vast majority of WLANs never diverts from the default parameter set. Accordingly, lowering a WLAN's medium access parameter set only supports neighboring WLANs in increasing their share of the wireless medium. Increasing the medium access parameter set for APs isn't possible either since the collision probability increases then. Thus, the proposed technology may be useful in overcoming this issue.

In a particular set of example embodiments, the proposed technology introduces modifications to the IEEE 802.11 WLAN technology OFDM PHY header structure. In modifying the PHY header structure, the proposed technology introduces identification or addressing information that allows receiving stations to decide if the frame belongs to its own WLAN or a neighboring WLAN.

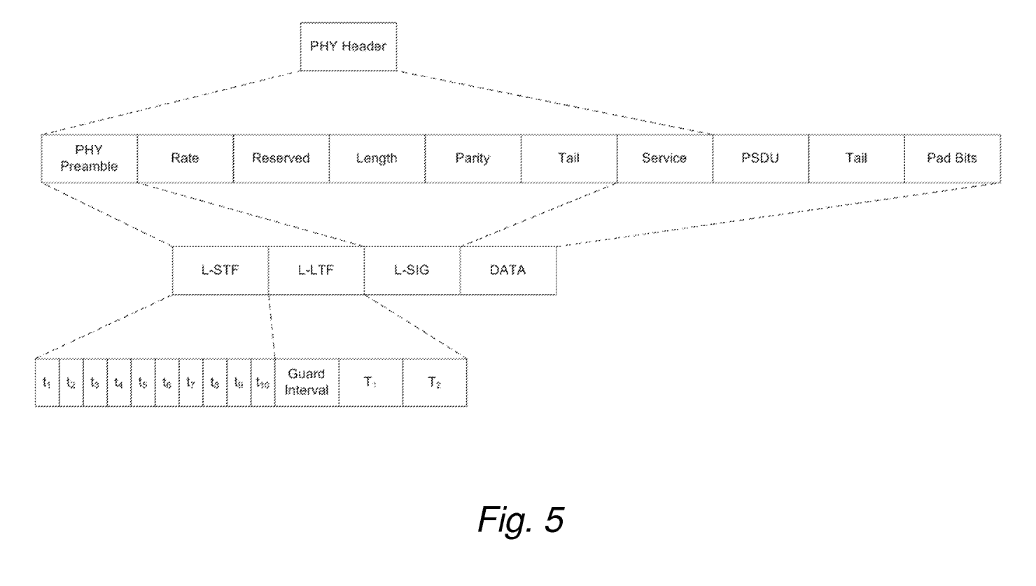

FIG. 5 presents the general outline of the IEEE 802.11 frame format using an OFDM PHY. In general, all IEEE 802.11 OFDM PHYs implement this frame structure. The IEEE 802.11 PHY preamble consists of a Legacy Short Training field (L-STF) and a Legacy Long Training field (L-LTF). The L-STF consists of ten short training symbols, t₁ to t₁₀. Each of the short training symbols has the same fixed characteristic.

However, communication units or devices implementing the proposed technology may be able to slightly vary each training symbol without affecting the purpose of robustly synchronizing the receiver. Thus, communication units or devices implementing the proposed technology may carry extra information within each short training symbol. It should be noted that units or devices, i.e. legacy devices, that do not implement the proposed technology will not recognize the modification, while still being able to synchronize to the frame.

In a particular example embodiment, the short training symbol allows each symbol t₁ to t₁₀ to carry a single bit of information. Consequently, ten bits of extra information can be carried in the L-STF. In IEEE 802 compliant standards, MAC layer address information is either 48 bits or 64 bits long, see reference [1]. In IEEE 802.11, stations use a 48 bit MAC address.

To compress the indication of buffered data being present at an IEEE 802.11 AP or mesh station, the IEEE 802.11 standard introduces the concept of association identifier, AID. The central AP assigns an AID in the range of 1 to 2007 to each of its associated stations. Accordingly, 11 bits (2¹¹=2048) are needed to differentiate a total of 2007 different AIDs. The Most Significant Bit, MSB, of these AIDs can be signaled in bit 4 of the L-SIG field that is currently reserved in the IEEE 802.11. AIDs in the range of 1 to 2007 indicate an individually addressed message. Other AID values are reserved. A reserved AID, e.g. AID equal 2048 (all bits set to 1), indicates a group addressed message.

Embedding AID information into the PHY preamble allows for at least one of the following uses:
AID identifying an individual station: A WLAN may be configured so that the AID hidden in the PHY preamble addresses an individual STA. An STA that receives a frame that contains an AID indicating this station's AID or a group address AID hidden in the L-STF and the L-SIG's reserved bit, continues reception of this frame. The station then processes the following PHY DATA field of this frame. A station whose AID does not match or that does not receive a group addressed AID reads and processes the length field contained in the L-SIG field as described in standard IEEE 802.11. The station then discontinues processing the remainder of this frame.
The AID embedded into the PHY preamble that identifies an individual STA may also be used to generate Negative Acknowledgments (NACK). With the PHY preamble being very robust the AID of the intended receiver contained within the preamble has a high probability of successful reception. Consequently, the intended receiver can transmit a NACK frame to the sender in case the intended receiver cannot decode the DATA field that might be encoded at a faster but yet more sensitive MCS. Without the MAC address being embedded into the PHY header a station would not be able to generate a NACK in such case. In the IEEE 802.11 standard for example, there is addressing information in the Medium Access Control, MAC, header, but it might be the case that this information cannot be correctly decoded. The proposed technology thus provides an additional identification in the PHY preamble of the PHY header, in addition to the information in the MAC header. Therefore, the proposed technology allows for the potential introduction of a closed loop link adaptation mode whereas existing implementations need to rely on open loop, simple trial and error mechanisms to estimate the best MCS.
AID identifying a WLAN: A WLAN may be configured so that the AID hidden in the PHY preamble is used as an identifier for this WLAN. During setup of a WLAN each WLAN randomly selects one AID value. The selection of this random AID value occurs at the WLAN initiating device. Usually this is the AP. Having selected one AID as identifier for this WLAN, all members of the WLAN embedded this AID in any of their transmissions in the PHY preamble. Consequently, all members of the WLAN can differentiate between transmissions by members of their own WLAN or transmissions of members of a different WLAN. Consequently, an STA may defer its access to the wireless medium if it detects a transmission by a STA of its own WLAN. However, the STA may continue accessing the wireless medium in case it detects a transmission of a STA of a different WLAN. The STA may take secondary conditions (e.g. the signal strength of the received frame of a STA of different WLAN) into account to decide if the ongoing transmission can be ignored or needs to be deferred to.

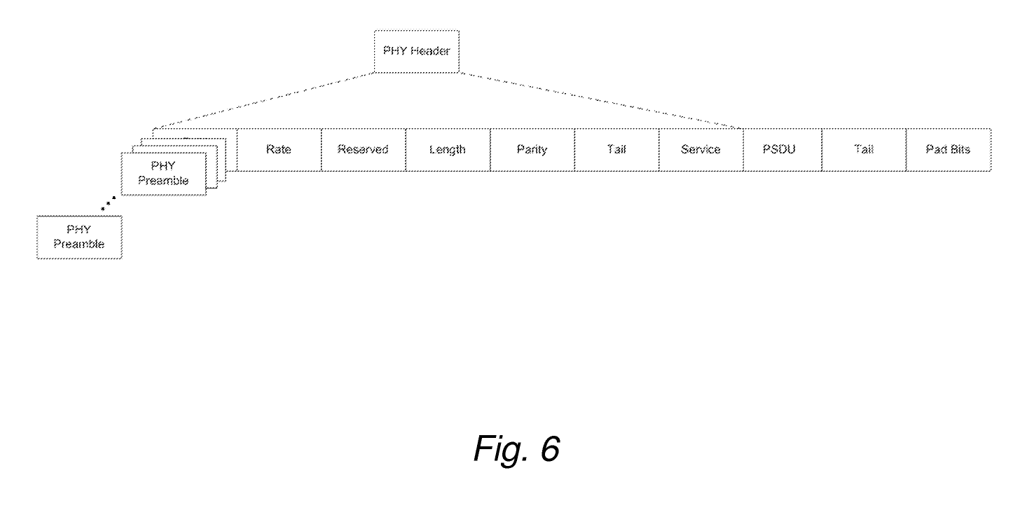

In another set of example embodiments, a set of p unique preambles is defined, as schematically illustrated in FIG. 6. All preambles have very good cross-correlation properties, for instance they may be mutually orthogonal. Thus, each preamble can be differentiated from any other preamble. One of the set of p preambles might be reserved as the legacy preamble for devices that are not implementing the proposed technology.

With p unique preambles the proposed technology allows for at least one of the following modes of operation:
For a set of p preambles with p≧2, at least one preamble is reserved for use by client devices, i.e. stations, STAs, not implementing the proposed technology. Legacy STAs and all Access Point, AP, devices (implementing or not implementing the proposed technology) use the existing legacy preamble with all of their transmissions. Since the new PHY preambles are unknown to legacy devices, legacy STAs will use an Energy Detection, ED, threshold that is 20 dB higher than the Signal Detection, SD, threshold, as channel busy criterion. Thus, legacy stations can potentially transmit concurrently to an ongoing transmission of a new STA. Since APs always use the legacy preamble with their transmissions, all client devices defer to an AP's transmission. Thus, AP transmissions benefit from higher Signal to Noise plus Interference Ratio, SINR, values as the number of concurrent transmissions is reduced compared to transmissions by STAs implementing the proposed technology.
This mode extends the previous mode as follows: STAs that implement the proposed technology decode and process all frames carrying the new preamble or a legacy preamble. However, if a STA detects a transmission that uses the new preamble it is aware that this transmission was initiated by another STA also implementing the new preamble. The STA has the opportunity to consider secondary conditions to decide if concurrent use of the wireless medium is possible. Therefore, STAs implementing the proposed technology may increase spatial frequency reuse for all of their transmissions since other STAs may transmit simultaneously if the other STA is a legacy STA considering the ED threshold only, or in case the other STA also implements the proposed technology and the other station has further criteria to identify opportunities for concurrent use of the wireless medium.
For a set of p preambles with p being large, neighboring APs may each select a unique preamble, taking into account what other neighboring APs are using. The preambles may also be configured by Operation and Maintenance, O&M. An AP may observe neighboring transmissions before initiating a WLAN to ensure that the preamble that the AP uses is currently not in use by any other neighbor WLAN. Information about the preamble to be used may be conveyed in regularly transmitted beacon frames and probe response frames that are sent to STAs searching for a WLAN. Using a specific preamble for its WLAN the AP enhances the previous mode(s) of operation. Whereas in the previous mode of operation all STAs implementing the proposed technology use the same new preamble, the present mode allows STAs implementing the proposed technology to use a preamble that uniquely identifies the WLAN that they associate with. Thus, STAs implementing the present mode of operation are able to identify transmissions of STAs of neighboring WLANs also implementing the proposed technology. The new STAs may choose to concurrently use the wireless medium whenever a new STA of a neighboring WLAN transmits. Secondary conditions may define the signal strength threshold when such concurrent usage of the wireless medium is permissible.

The coexistence of devices that use secondary conditions enabling concurrent transmissions and legacy devices is important as proposals in 802.11 TGax foresee to modify the carrier sensing threshold for new devices. In lowering the current, static thresholds, chances are increased that devices transmit simultaneously. In many cases the remaining Signal to Noise plus Interference Ratio, SINR, will be sufficient for all concurrent frame exchange sequences to succeed. Since legacy devices cannot implement dynamic channel sensing thresholds that are needed for increasing the spatial frequency reuse, using a modified PHY preamble helps to increase channel access probabilities for legacy devices. Since the new PHY preamble prevents legacy devices from decoding the PHY header, legacy devices cannot predict the frame duration and thus return to the idle state. Afterwards, legacy stations may perform the back-off procedure to gain access to the wireless medium. Thus, legacy stations can potentially transmit concurrently to an ongoing transmission of a new device. Thereby, spatial frequency reuse is increased for all devices sharing the same frequency channel.

According to example embodiments described herein, the proposed technology introduces identification information to the PHY preamble. Thereby, the proposed technology allows for increased frequency channel reuse. In a set of example embodiments, the proposed technology encourages legacy stations to transmit concurrently to transmissions of new devices. The proposed technology also can help to reduce the imbalance between successful channel access of APs that serve the downlink and stations that transmit in the uplink direction.

It will be appreciated that the methods and devices described herein can be combined and re-arranged in a variety of ways.

For example, embodiments may be implemented in hardware, or in software for execution by suitable processing circuitry, or a combination thereof.

The steps, functions, procedures, modules and/or blocks described herein may be implemented in hardware using any conventional technology, such as discrete circuit or integrated circuit technology, including both general-purpose electronic circuitry and application-specific circuitry.

Particular examples include one or more suitably configured digital signal processors and other known electronic circuits, e.g. discrete logic gates interconnected to perform a specialized function, or Application Specific Integrated Circuits (ASICs).

Alternatively, at least some of the steps, functions, procedures, modules and/or blocks described herein may be implemented in software such as a computer program for execution by suitable processing circuitry such as one or more processors or processing units.

Examples of processing circuitry includes, but is not limited to, one or more microprocessors, one or more Digital Signal Processors (DSPs), one or more Central Processing Units (CPUs), video acceleration hardware, and/or any suitable programmable logic circuitry such as one or more Field Programmable Gate Arrays (FPGAs), or one or more Programmable Logic Controllers (PLCs).

It should also be understood that it may be possible to re-use the general processing capabilities of any conventional device or unit in which the proposed technology is implemented. It may also be possible to re-use existing software, e.g. by reprogramming of the existing software or by adding new software components.

The proposed technology thus also provides a communication unit configured for operation in a Wireless Local Area Network, WLAN, environment. The communication unit is configured to embed identification information into at least the Physical, PHY, preamble of the PHY header of a WLAN frame. The communication unit is also configured to perform transmission of the WLAN frame for enabling a recipient to identify i) the communication unit and/or ii) a WLAN to which the communication unit is associated, and/or iii) whether the transmission originates from a member of a specific group of communication units based on the embedded identification information.

By way of example, the communication unit may be configured to perform transmission of the WLAN frame for enabling a recipient to take a decision on concurrent use of the shared wireless medium.

For example, the communication unit may be configured to perform transmission of the WLAN frame for enabling a recipient to identify a WLAN and decide whether to ignore a busy medium condition based on the identified WLAN.

In a particular example, the communication unit is configured to perform transmission of the WLAN frame for enabling a recipient to identify whether the transmission originates from a member of a specific group of client devices, and to consider, if the transmission originates from a member of the specific group of client devices, secondary conditions to decide whether concurrent use of the wireless medium is allowed.

In another example, the communication unit is configured to perform transmission of the WLAN frame for enabling a recipient to identify the communication unit and provide, upon unsuccessful data decoding, Negative Acknowledgement, NACK, feedback to the identified communication unit.

Optionally, the communication unit may be configured to embed identification information representative of an Association Identifier, AID into at least the Physical, PHY, preamble of the PHY header of the WLAN frame.

Further, the proposed technology provides a communication unit configured for operation in a Wireless Local Area Network, WLAN, environment. The communication unit is configured to receive a WLAN frame having identification information embedded into at least the Physical, PHY, preamble of the PHY header of the WLAN frame. The communication unit is also configured to extract the identification information from the received WLAN frame. The communication unit is further configured to identify i) a sender transmitting the WLAN frame and/or ii) a WLAN to which the sender transmitting the WLAN frame is associated, and/or iii) whether the sender transmitting the WLAN frame belongs to a specific group of communication units based on the identification information.

By way of example, the communication unit may be configured to take a decision on concurrent use of the shared wireless medium based on the identification information.

For example, the communication unit may be configured to identify a WLAN and decide whether to ignore a busy medium condition based on the identified WLAN.

In a particular example, the communication unit may be configured to identify whether the sender transmitting the WLAN frame belongs to a specific group of client devices, and to consider, if the sender transmitting the WLAN frame belongs to the specific group of client devices, secondary conditions to decide whether concurrent use of the wireless medium is allowed.

In another example, the communication unit is configured to identify the sender transmitting the WLAN frame and provide, upon unsuccessful data decoding, Negative Acknowledgement, NACK, feedback to the identified sender.

In an optional embodiment, the communication unit may be configured to extract the identification information representative of an Association Identifier, AID, from the received WLAN frame.

The proposed technology may be applied to wireless devices such as client devices or stations, as well as access points and equivalent network nodes.

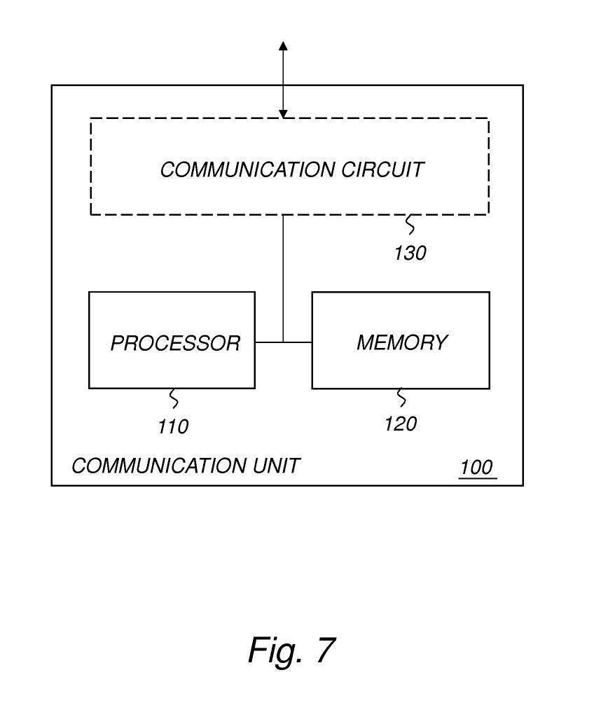

FIG. 7 is a schematic block diagram illustrating an example of a communication unit comprising a processor and an associated memory according to an embodiment. In this example, the communication unit 100 comprises a processor 110 and a memory 120, said memory comprising instructions executable by the processor, whereby the processor is operative to embed identification information into at least the PHY preamble of the PHY header of a WLAN frame and prepare for transmission of the WLAN frame.

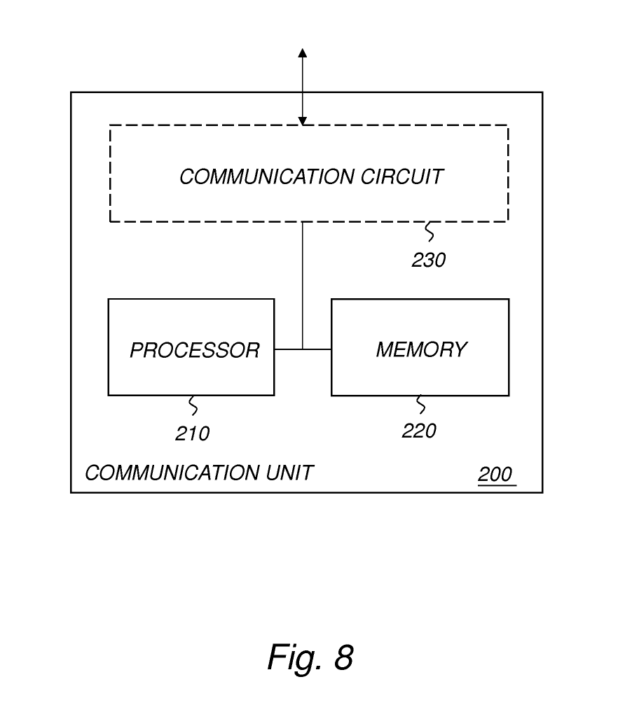

FIG. 8 is a schematic block diagram illustrating an example of a complementary communication unit comprising a processor and an associated memory according to an embodiment. In this example, the communication unit 200 comprises a processor 210 and a memory 220, said memory comprising instructions executable by the processor, whereby the processor is operative to receive the WLAN frame, extract identification information and perform identification based on the identification information.

The communication unit 100; 200 may also include communication circuitry 130; 230. The communication circuitry 130; 230 may include functions for wired and/or wireless communication with other devices and/or network nodes in the network. In a particular example, the communication unit such as a client device or an access point or equivalent network node may include radio circuitry for communication with one or more other nodes, including transmitting and/or receiving information. The communication circuitry may be interconnected to the processor 110; 210 and/or memory 120; 220.

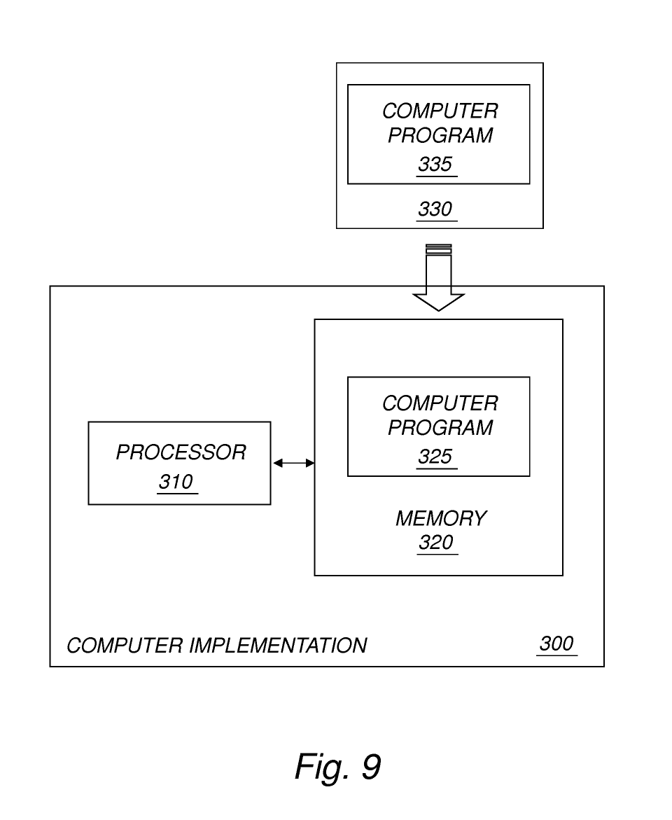

FIG. 9 is a schematic block diagram illustrating an example of a computer implementation according to an embodiment.

In this particular example, at least some of the steps, functions, procedures, modules and/or blocks described herein are implemented in a computer program 325; 335, which is loaded into the memory 320 for execution by processing circuitry including one or more processors 310. The processor(s) and memory are interconnected to each other to enable normal software execution. An optional input/output device may also be interconnected to the processor(s) and/or the memory to enable input and/or output of relevant data such as input parameter(s) and/or resulting output parameter(s).

Generally, the term “processor” should be interpreted in a general sense as any system or device capable of executing program code or computer program instructions to perform a particular processing, determining or computing task.

The processing circuitry including one or more processors is thus configured to perform, when executing the computer program, well-defined processing tasks such as those described herein.

The processing circuitry does not have to be dedicated to only execute the above-described steps, functions, procedure and/or blocks, but may also execute other tasks.

In a particular embodiment, there is provided a computer program comprising instructions, which when executed by at least one processor, cause the at least one processor to:
embed identification information into at least the Physical, PHY, preamble of the PHY header of a Wireless Local Area Network, WLAN, frame; and
forward the WLAN frame for transmission for enabling a recipient to identify i) the communication unit and/or ii) a WLAN to which the communication unit is associated, and/or iii) whether the transmission originates from a member of a specific group of communication units based on the embedded identification information.

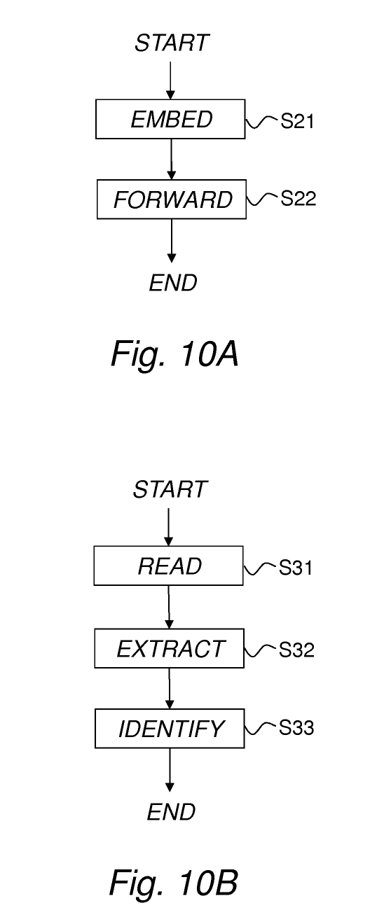

FIG. 10A is a corresponding computer flow diagram illustrating the embedding and forwarding sequence of computer program actions.

In another particular embodiment, there is provided a computer program comprising instructions, which when executed by at least one processor, cause the at least one processor to:
read a Wireless Local Area Network, WLAN, frame having identification information embedded into at least the Physical, PHY, preamble of the PHY header of the WLAN frame;
extract the identification information from the received WLAN frame; and
identify i) a sender transmitting the WLAN frame and/or ii) a WLAN to which the sender transmitting the WLAN frame is associated, and/or iii) whether the sender transmitting the WLAN frame belongs to a specific group of communication units based on the identification information.

FIG. 10B is a corresponding computer flow diagram illustrating the reading, extracting and identifying sequence of computer program actions.

The proposed technology also provides a carrier comprising the computer program, wherein the carrier is one of an electronic signal, an optical signal, an electromagnetic signal, a magnetic signal, an electric signal, a radio signal, a microwave signal, or a computer-readable storage medium.

In particular, there is provided a computer-program product comprising a computer-readable medium having stored thereon a computer program as described herein.

By way of example, the software or computer program 325; 335 may be realized as a computer program product, which is normally carried or stored on a computer-readable medium 320; 330, in particular a non-volatile medium. The computer-readable medium may include one or more removable or non-removable memory devices including, but not limited to a Read-Only Memory (ROM), a Random Access Memory (RAM), a Compact Disc (CD), a Digital Versatile Disc (DVD), a Blu-ray disc, a Universal Serial Bus (USB) memory, a Hard Disk Drive (HDD) storage device, a flash memory, a magnetic tape, or any other conventional memory device. The computer program may thus be loaded into the operating memory of a computer or equivalent processing device for execution by the processing circuitry thereof.

The flow diagrams presented herein may be regarded as computer flow diagrams, when performed by one or more processors. A corresponding apparatus may thus be defined as a group of function modules, where each step performed by the processor corresponds to a function module. In this case, the function modules are implemented as a computer program running on the processor.

The computer program residing in memory may thus be organized as appropriate function modules configured to perform, when executed by the processor, at least part of the steps and/or tasks described herein.

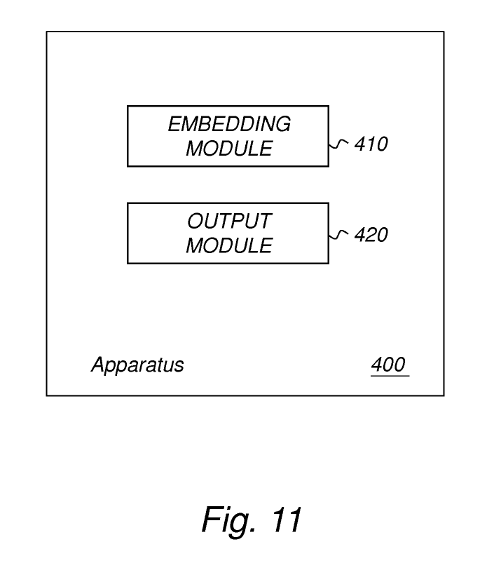

FIG. 11 is a schematic block diagram illustrating an example of an apparatus according to an embodiment. The apparatus 400 comprises an embedding module 410 for embedding identification information into at least the Physical, PHY, preamble of the PHY header of a WLAN frame. The apparatus 400 also comprises an output module 420 for outputting the WLAN frame for transmission for enabling a recipient to identify i) the communication unit and/or ii) a WLAN to which the communication unit is associated, and/or iii) whether the transmission originates from a member of a specific group of communication units based on the embedded identification information.

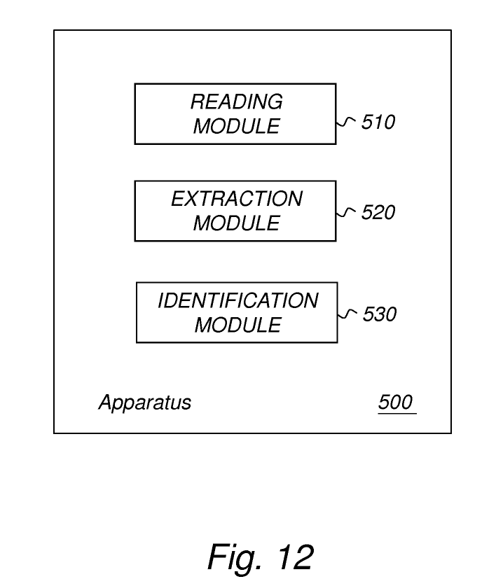

FIG. 12 is a schematic block diagram illustrating an example of an apparatus according to another embodiment. The apparatus 500 comprises a reading module 510 for reading a WLAN frame having identification information embedded into at least the Physical, PHY, preamble of the PHY header of the WLAN frame. The apparatus 500 also comprises an extraction module 520 for extracting the identification information from the received WLAN frame. The apparatus 500 further comprises an identification module 530 for identifying i) a sender transmitting the WLAN frame and/or ii) a WLAN to which the sender transmitting the WLAN frame is associated, and/or iii) whether the sender transmitting the WLAN frame belongs to a specific group of communication units based on the identification information.

Alternatively it is possibly to realize the modules in FIG. 11 and/or FIG. 12 predominantly by hardware modules, or alternatively by hardware. The extent of software versus hardware is purely implementation selection.

The apparatus of FIG. 11 and/or FIG. 12 may be implemented in a communication unit such as a wireless device or an access point or equivalent network node.

The embodiments described above are merely given as examples, and it should be understood that the proposed technology is not limited thereto. It will be understood by those skilled in the art that various modifications, combinations and changes may be made to the embodiments without departing from the present scope as defined by the appended claims. In particular, different part solutions in the different embodiments can be combined in other configurations, where technically possible.

### ABBREVIATIONS

STA Station
WLAN Wireless Local Area Network
OBSS Overlapping Basic Service Set
BSS Basic Service Set
AP Access Point
CSMA/CA Carrier Sense with Multiple Access/Collision Avoidance
BPSK Binary Phase Shift Keying
QPSK Quadrature Phase Shift Keying
MCS Modulation and Coding Scheme
L-SIG Legacy Signal Field
L-LTF Legacy Long Training Field
L-STF Legacy Short Training Field
MSB Most Significant Bit
LSB Least Significant Bit
PSDU PHY Service Data Unit
OFDM Orthogonal Frequency Division Multiplexing
AID Association ID
MAC Medium Access Control (Layer)
PHY Physical Layer
MPDU MAC Protocol Data Unit
MSDU MAC Service Data Unit
RA Receiver Address
TG Task Group
ED Energy Detection
DSC Dynamic Sensitivity Control
ARQ Automatic Repeat Request
SINR Signal to Noise plus Interference
FEC Forward Error Correction
NACK Negative Acknowledgment

### REFERENCES

[1] IEEE 802-2014, “IEEE Standard for Local and Metropolitan Area Networks: Overview and Architecture.

[2] J. Egan (Marvell), “PLC Neighboring Networks,” July 2012. [Online]. Available: http://www.marvell.com/wireline-networking/ghn/assets/Neighboring-Networks.pdf.

[3] IEEE 802.11-2012, “IEEE Standard for Information technology—Telecommunications and information exchange between systems Local and metropolitan area networks—Specific requirements Part 11: Wireless LAN Medium Access Control (MAC) and Physical Layer (PHY) Specifications”.

[4] E. Dahlman, S. Parkvall, and J. Skold, “4G: LTE/LTE-Advanced for Mobile Broadband—LTE/LTE-Advanced for Mobile Broadband,” Academic Press, March 2011, ISBN 978-0123854896.

[5] International Patent Application WO 2014/074832.

[6] IEEE 802.11ah, “Draft Standard for Information technology—Telecommunications and information exchange between systems Local and metropolitan area networks—Specific requirements—Part 11: Wireless LAN Medium Access Control (MAC) and Physical Layer (PHY) Specifications—Amendment 6: Sub 1 GHz License Exempt Operation,” Draft 2.2, October 2014.

[7] J. Son and J. S. Kwak, “Further Considerations on Enhanced CCA for 11 ax,” IEEE 802.11 submission 802.11-14/847r0, July 2014.

[8] S. Choudhury, A. Cavalcante, F. Chaves, E. Almeida, F. Abinader Jr., E. Tuomaala, K. Doppler, and J. Kneckt, “Impact of CCA adaptation on spatial reuse in dense residential scenario,” IEEE 802.11 submission 802.11-14/0861r0, July 2014.

[9] U.S. Patent Application 2014 286203.

1. A method of operation of a communication unit in a Wireless Local Area Network (WLAN) environment, wherein the method comprises the steps of:
the communication unit embedding identification information into at least the Physical (PHY) preamble of the PHY header of a WLAN frame; and
the communication unit performing transmission of the WLAN frame for enabling a recipient to identify at least one of the following, based on the identification information:
the communication unit;
a WLAN to which the communication unit is associated; and
whether the transmission originates from a member of a specific group of communication units.

2. The method of claim 1, wherein the identification information enables the recipient to take a decision on concurrent use of the shared wireless medium.

3. The method of claim 1, wherein the identification information enables the recipient to identify a WLAN and decide whether to ignore a busy medium condition based on the identified WLAN.

4. The method of claim 1, wherein the identification information enables the recipient to identify a WLAN and defer access to the wireless medium if the transmission of the WLAN frame originates from a member of the recipient's own WLAN, and allow or contend for access to the wireless medium if the transmission of the WLAN frame originates from a member of a different WLAN.

5. The method of claim 1, wherein the identification information enables the recipient to identify whether the transmission originates from a member of a specific group of client devices.

6. The method of claim 5, wherein the recipient is a client device and the identification information enables the recipient to identify whether the transmission originates from another client device that is using the same identification information in the PHY preamble as the recipient.

7. The method of claim 5, wherein the specific group of client devices belong to the same WLAN.

8. The method of claim 5, wherein the identification information enables the recipient to consider secondary conditions to decide whether concurrent use of the wireless medium is allowed.

9. The method of claim 1, wherein the identification information enables the recipient to identify the communication unit and provide, upon unsuccessful data decoding, Negative Acknowledgement (NACK) feedback to the identified communication unit.

10. The method of claim 1, wherein the identification information is representative of an Association Identifier (AID).

11. The method of claim 10, wherein the AID is embedded in the Legacy Short Training Field (L-STF) and a selected bit of the Legacy Signal Field (L-SIG) of the PHY header.

12. The method of claim 10, wherein the AID is representative of an individual communication unit, a group addressed frame, or an individual WLAN.

13. The method of claim 1, wherein said communication unit is an access point or a wireless device.

14. A method of operation of a communication unit in a Wireless Local Area Network (WLAN) environment, wherein the method comprises the steps of:
the communication unit receiving a WLAN frame having identification information embedded into at least the Physical (PHY), PHY, preamble of the PHY header of the WLAN frame;
the communication unit extracting the identification information from the received WLAN frame; and
the communication unit identifying at least one of the following, based on the identification information:
a sender transmitting the WLAN frame;
a WLAN to which the sender transmitting the WLAN frame is associated; and
whether the sender transmitting the WLAN frame belongs to a specific group of communication units.

15. The method of claim 14, wherein the communication unit takes a decision on concurrent use of the shared wireless medium based on the identification information.

16. The method of claim 14, wherein the communication unit identifies a WLAN and decides whether to ignore a busy medium condition based on the identified WLAN.

17. The method of claim 14, wherein the communication unit identifies a WLAN and defers access to the wireless medium if the received WLAN frame originates from a member of the communication unit's own WLAN, and allows or contends for access to the wireless medium if the received WLAN frame originates from a member of a different WLAN.

18. The method of claim 14, wherein the communication unit identifies whether the sender transmitting the WLAN frame belongs to a specific group of client devices.

19. The method of claim 18, wherein the communication unit is a client device and the communication unit identifies whether the received WLAN frame originates from another client device that is using the same identification information in the PHY preamble as the communication unit.

20. The method of claim 18, wherein the specific group of client devices belong to the same WLAN.

21. The method of claim 18, wherein the communication unit considers, if the sender transmitting the WLAN frame belongs to a specific group of client devices, secondary conditions to decide whether concurrent use of the wireless medium is allowed.

22. The method of claim 14, wherein the communication unit identifies the sender transmitting the WLAN frame and provides, upon unsuccessful data decoding, Negative Acknowledgement (NACK) feedback to the identified sender.

23. The method of claim 14, wherein the identification information is representative of an Association Identifier (AID).

24. The method of claim 23, wherein the AID is embedded in the Legacy Short Training Field (L-STF) and a selected bit of the Legacy Signal Field (L-SIG) of the PHY header.

25. The method of claim 23, wherein the AID is representative of an individual communication unit, a group addressed frame, or an individual WLAN.

26. The method of claim 14, wherein said communication unit is an access point or a wireless device.

27. A communication unit configured for operation in a Wireless Local Area Network (WLAN) environment,
wherein the communication unit is configured to embed identification information into at least the Physical (PHY) preamble of the PHY header of a WLAN frame; and
wherein the communication unit is configured to perform transmission of the WLAN frame for enabling a recipient to identify at least one of the following, based on the identification information:
the communication unit;
a WLAN to which the communication unit is associated; and
whether the transmission originates from a member of a specific group of communication units.

28. The communication unit of claim 27, wherein the communication unit is configured to perform transmission of the WLAN frame for enabling a recipient to take a decision on concurrent use of the shared wireless medium.

29. The communication unit of claim 27, wherein the communication unit is configured to perform transmission of the WLAN frame for enabling a recipient to identify a WLAN and decide whether to ignore a busy medium condition based on the identified WLAN.

30. The communication unit of claim 27, wherein the communication unit is configured to perform transmission of the WLAN frame for enabling a recipient to identify whether the transmission originates from a member of a specific group of client devices, and to consider, if the transmission originates from a member of the specific group of client devices, secondary conditions to decide whether concurrent use of the wireless medium is allowed.

31. The communication unit of claim 27, wherein the communication unit is configured to perform transmission of the WLAN frame for enabling a recipient to identify the communication unit and provide, upon unsuccessful data decoding, Negative Acknowledgement (NACK) feedback to the identified communication unit.

32. The communication unit of claim 27, wherein the communication unit is configured to embed identification information representative of an Association Identifier (AID) into at least the Physical (PHY) preamble of the PHY header of the WLAN frame.

33. The communication unit of claim 27, wherein the communication unit comprises a processor and a memory, said memory comprising instructions executable by the processor, whereby the processor is operative to embed identification information into at least the PHY preamble of the PHY header of a WLAN frame and prepare for transmission of the WLAN frame.

34. A communication unit configured for operation in a Wireless Local Area Network (WLAN) environment,
wherein the communication unit is configured to receive a WLAN frame having identification information embedded into at least the Physical preamble of the PHY header of the WLAN frame;
wherein the communication unit is configured to extract the identification information from the received WLAN frame; and
wherein the communication unit is configured to identify at least one of the following, based on the identification information:
a sender transmitting the WLAN frame;
a WLAN to which the sender transmitting the WLAN frame is associated; and
whether the sender transmitting the WLAN frame belongs to a specific group of communication units.

35. The communication unit of claim 34, wherein the communication unit is configured to take a decision on concurrent use of the shared wireless medium based on the identification information.

36. The communication unit of claim 34, wherein the communication unit is configured to identify a WLAN and decide whether to ignore a busy medium condition based on the identified WLAN.

37. The communication unit of claim 34, wherein the communication unit is configured to identify whether the sender transmitting the WLAN frame belongs to a specific group of client devices, and to consider, if the sender transmitting the WLAN frame belongs to the specific group of client devices, secondary conditions to decide whether concurrent use of the wireless medium is allowed.

38. The communication unit of claim 34, wherein the communication unit is configured to identify the sender transmitting the WLAN frame and provide, upon unsuccessful data decoding, Negative Acknowledgement, NACK, feedback to the identified sender.

39. The communication unit of claim 34, wherein the communication unit is configured to extract the identification information representative of an Association Identifier, AID, from the received WLAN frame.

40. The communication unit of claim 34, wherein the communication unit comprises a processor and a memory, said memory comprising instructions executable by the processor, whereby the processor is operative to receive the WLAN frame, extract identification information and perform identification based on the identification information.

41. The communication unit of claim 34, wherein the communication unit is an access point or a wireless device.

42. A non-transitory computer-readable medium storing a computer program comprising instructions that, when executed by at least one processor of a communication unit configured for operation in a Wireless Local Network (WLAN) environment, cause the at least one processor to:
embed identification information into at least the Physical (PHY) preamble of the PHY header of a WLAN frame; and
forward the WLAN frame for transmission, for enabling a recipient to identify at least one of the following based on the identification information:
the communication unit;
a WLAN to which the communication unit is associated; and
whether the transmission originates from a member of a specific group of communication units.

43. A non-transitory computer-readable medium storing a computer program comprising instructions that, when executed by at least one processor of a communication unit configured for operation in a Wireless Local Area Network (WLAN) environment, cause the at least one processor to:
read a WLAN frame having identification information embedded into at least the Physical (PHY) preamble of the PHY header of the WLAN frame;
extract the identification information from the received WLAN frame; and
identify at least one of the following based on the identification information;
a sender transmitting the WLAN frame;
a WLAN to which the sender transmitting the WLAN frame is associated; and
whether the sender transmitting the WLAN frame belongs to a specific group of communication units.

44. (canceled)

45. An apparatus for operation in a Wireless Local Area Network (WLAN) environment, wherein the apparatus comprises:
an embedding module for embedding identification information into at least the Physical (PHY) preamble of the PHY header of a WLAN frame; and
an output module for outputting the WLAN frame for transmission for enabling a recipient to identify at least one of the following, based on the identification information:
the communication unit;
a WLAN to which the communication unit is associated; and
whether the transmission originates from a member of a specific group of communication units.

46. An apparatus for operation in a Wireless Local Area Network (WLAN) environment, wherein the apparatus comprises:
a reading module for reading a WLAN frame having identification information embedded into at least the Physical (PHY) preamble of the PHY header of the WLAN frame;
an extraction module for extracting the identification information from the received WLAN frame; and
an identification module for identifying at least one of the following, based on the identification information:
a sender transmitting the WLAN frame;
a WLAN to which the sender transmitting the WLAN frame is associated; and
whether the sender transmitting the WLAN frame belongs to a specific group of communication units.
